(19) United States
(12) Patent Application Publication
(10) Pub. No.: US 2012/0263066 A1
(43) Pub. Date: Oct. 18, 2012

(54) COMMUNICATIONS APPARATUS

(75) Inventors: Jonathan Ephraim David Hurwitz, Edinburgh (GB); Josemaria Ogara Fernandez de Arroyabe, Barcelona (ES); David Ruiz Lopez, Barcelona (ES); Juan Carlos Riveiro Insua, Barcelona (ES)

(73) Assignee: BROADCOM EUROPE LIMITED, London, England (GB)

(21) Appl. No.: 13/515,320

(22) PCT Filed: Dec. 17, 2010
(86) PCT No.: PCT/GB10/52133

§ 371 Date: Jun. 26, 2012

(30) Foreign Application Priority Data
Dec. 17, 2009 (GB) 0922091.4

(51) Int. Cl. H04W 84/12; H04W 24/00; H04B 3/54

(52) U.S. Cl. 370/252; 370/338

(57) ABSTRACT

Disclosed is a communications apparatus comprising: a first medium interface circuit that communicates data over a powerline medium, a first medium access controller, for controlling the first medium interface circuit, said first medium access controller having a first MAC address; a second medium interface circuit that is 802.11 compliant and which communicates data wirelessly, a second medium access controller, which controls the second medium interface circuit, said second medium access controller having a second MAC address; and a communications medium access controller that is operative to provide for communication of data simultaneously over the powerline medium and wirelessly by way of the first and second medium interface circuits; wherein said first medium interface circuit and said second medium interface circuit are linked at the layer II level of the OSI model. A network of said devices is also disclosed, the network possibly including device connected via only one of the media.

### FIELD OF THE INVENTION

The present invention relates to communications apparatus and network apparatus comprising such communications apparatus.

### BACKGROUND TO THE INVENTION

It is known to provide for data communication between two modem apparatus by way of different media. For example, WO 2008/142449 (to the present applicant) describes modem apparatus that is operative to transmit and receive data over powerlines, telephone lines and coaxial cables. According to known approaches, the modem apparatus is operative to choose one of the media over which to communicate with a particular medium being chosen in dependence on quality of service requirements, such as latency and bandwidth. Typically, known modem apparatus implements Ethernet based protocols that force communications through a single medium. Known modem apparatus may, for example, communicate wirelessly by means of an 802.11 compliant device in accordance with a spanning tree protocol, which is operative to reduce the likelihood of data loops being formed.

The present inventors have appreciated that such known data communications apparatus have shortcomings. More specifically, the present inventors have appreciated that communications apparatus having the capability to communicate over plural different media may be improved to provide for better utilisation of the plural different media.

It is therefore an object for the present invention to provide improved communications apparatus that is operable to provide for communication of data over different media.

### STATEMENT OF INVENTION

According to a first aspect of the present invention there is provided communications apparatus comprising:
a first medium interface circuit that is operable to communicate data over a powerline medium,
a first medium access controller, which is operable to control the first medium interface circuit, said first medium access controller having a first MAC address;
a second medium interface circuit that is 802.11 compliant and which is operable to communicate data wirelessly,
a second medium access controller, which is operable to control the second medium interface circuit, said second medium access controller having a second MAC address; and
a communications controller that is operable to provide for communication of data simultaneously over the powerline medium and wirelessly by way of the first and second medium interface circuits;
   wherein said first medium interface circuit and said second medium interface circuit are linked at the layer II level of the OSI model.

The present inventors have appreciated that powerline and wireless media are widely accessible. In the light of this appreciation and of the shortcomings of known communications apparatus the inventors have devised communications apparatus in which a communications controller is operative to provide for communication of data simultaneously over the powerline medium and wirelessly. The first and second medium interface circuits may operate asynchronously of each other. Thus, the communications apparatus can improve performance by making use of both of the powerline medium and the wireless medium by splitting data between the two media.

More specifically, the communications apparatus may comprise a routing controller that comprises routing data, the routing data determining the identity of an apparatus, such as a second communications apparatus, with which the communications apparatus is to communicate. For example and where the communications apparatus forms part of a network of such communications apparatus, the routing data may be in the form of a routing table containing device identifications for each of the other communications apparatus. Hence, all possible paths other than a path between the communications apparatus and the other apparatus may be effectively disabled. Therefore, there may be no need for a protocol, such as the spanning tree protocol, to avoid the formation of data loops.

The communications controller may be a system medium access controller that is operative to control each of the first and second medium access controllers.

The first medium access controller and the first medium interface circuit may be formed as part of a first unit, such as a first System on a Chip (SoC), and the second medium access controller and the second medium interface circuit may be formed as part of a second unit, such as a second System on a Chip (SoC). Alternatively, the first and second medium access controllers and the first and second interface circuits may form part of a single System on a Chip (SoC).

In a first embodiment, the communications controller may form part of the first unit.

In a second embodiment, the communications controller may form part of the second unit. More specifically and where the first unit comprises a third medium interface circuit that is configured to, in use, communicate data over a different wired medium, such as a coaxial cable, the first unit may comprise a convergence layer controller that is operative to control medium access controllers associated with the first and third medium interface circuits.

In each of the first and second embodiments, communications between the first and second units may be by means of a frame based standard, such as Ethernet according to the 802.3 standard. The Ethernet standard may be transmitted across one of several inter system connections, such as one of the following: MII, RMII, RvMII, GMII, RGMII, SMII, 10/100, 10/100/1000, USB1.1, USB2, USB3, SDIO, PCIe and PCI.

Data may be split between the first and second medium interface circuits in dependence on a quality of service measure. The quality of service measure may comprise at least one of: bandwidth, medium latency, extent of packet loss, a type of data to be communicated, such as movie or audio, and a condition of the data to be communicated. A quality of service metric may be determined as described in WO 2008/142450 (to the present applicant) or WO 2008/142449 (to the present applicant).

Where the data is split in dependence on a quality of service measure that depends on a condition of at least one of the powerline medium and wirelessly, the communications apparatus may comprise at least one of:
a first medium access controller that is operative to obtain information from the powerline medium; and
a second medium access controller that is operative to obtain information from the wireless medium.

More specifically, the communications apparatus may be operative to convey the information obtained from a medium to the communications controller. Where the communications controller forms part of one of a first unit comprising the first medium interface circuit and a second unit comprising the second medium interface circuit, the information obtained from the medium may be conveyed from one unit to the other by means of a communications link operating according to a frame based standard, such as Ethernet.

Alternatively or in addition, the communications apparatus may comprise at least a third medium interface circuit that is configured to, in use, communicate data over a medium different to the wired and the wireless media. More specifically, the third medium interface circuit may be configured to, in use, communicate data over a wired medium different to the wired medium of the first medium interface. For example, the first medium interface circuit may be configured to communicate data over powerline and the third medium interface circuit may be configured to communicate data over a coaxial cable. The first and third medium interface circuits may both form part of a first System on a Chip (SoC) and the second medium interface circuit may form part of a second System on a Chip (SoC). Alternatively, the first to third medium interface circuits may form part of the same System on a Chip (SoC) with an on chip communication means between each subsystem providing for communication according to a frame based standard, such as Ethernet.

Alternatively or in addition, a medium interface circuit may be configured to operate as a transceiver. Thus, the medium interface circuit may be operable to receive or transmit data.

According to a second aspect of the present invention, there is provided network apparatus comprising at least first and second communications apparatus according to the first aspect of the present invention, the first and second communications apparatus being in data communication with each other by way of each of the powerline medium and the wireless medium. Thus, both the powerline medium and the wireless medium provide a communications path between the first and second communications apparatus.

More specifically, the networking apparatus may be multi-media networking apparatus, e.g. installed or for installation in a residential or commercial building.

Further embodiments of the second aspect of the present invention may comprise one or more features of the first aspect of the present invention.

According to a third aspect of the present invention there is provided a communications apparatus comprising:
a first medium interface circuit that is configured to, in use, communicate data over a wired medium,
a first medium access controller, which is operative to control the first medium interface circuit, said first medium access controller having a first MAC address;
a second medium interface circuit and which is configured to, in use, communicate data wirelessly,
a second medium access controller, which is operative to control the second medium interface circuit, said second medium access controller having a second MAC address; and
a communications controller that is operative to provide for communication of data simultaneously over the wired medium and wirelessly by way of the first and second medium interface circuits;
wherein said first medium interface circuit and said second medium interface circuit are linked at the layer II level of the OSI model.

More specifically, the wired medium may be one of powerline, twisted pair and coaxial cable.

Alternatively or in addition, the second medium interface circuit may be 802.11 compliant.

Further embodiments of the third aspect of the present invention may comprise one or more features of the first or second aspects of the present invention.

### BRIEF DESCRIPTION OF DRAWINGS

Further features and advantages of the present invention will become apparent from the following specific description, which is given by way of example only and with reference to the accompanying drawings, in which:

FIG. 1 shows a communications network according to the present invention;

FIG. 2 is a representation of physical and medium access control layers in communications apparatus according to a first embodiment; and

FIG. 3 is a representation of physical and medium access control layers in communications apparatus according to a second embodiment.

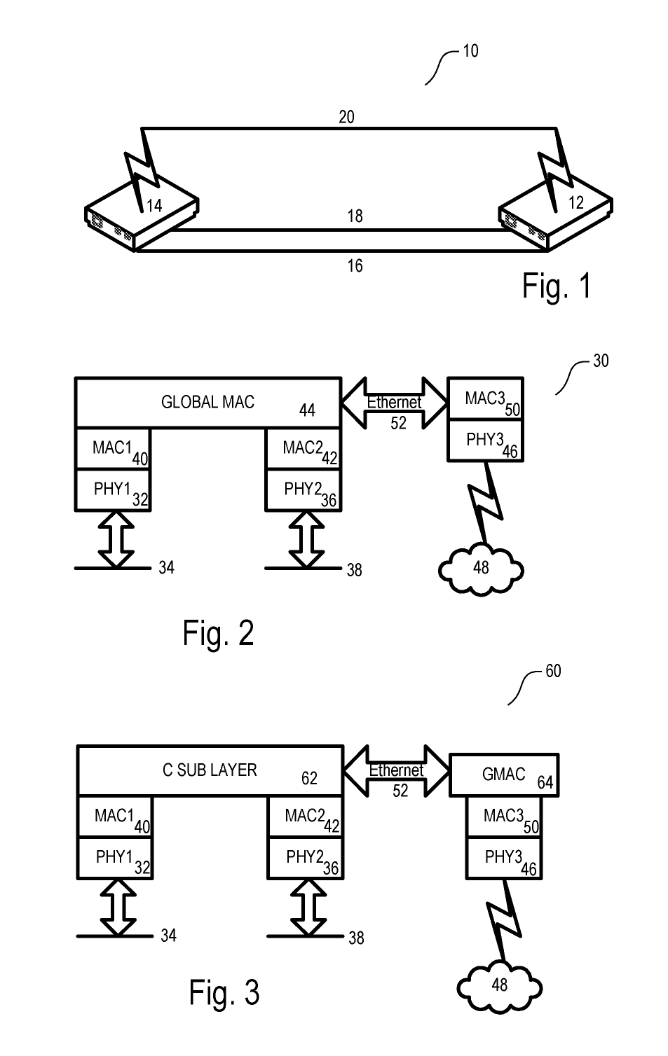

FIG. 1 shows first 12 and second 14 nodes (which each constitute communications apparatus) of a communications network 10 of consumer products in a building. The communications network 10 comprises further un-illustrated nodes that are connected to each other and to the nodes shown in FIG. 1 in the same fashion that the first and second nodes are connected to each other. The first and second nodes 12, 14 are connected to each other by already installed communications media. More specifically, the already installed communications media consist of: a powerline cable 16 (which constitutes a powerline medium); a coaxial cable 18 (which constitutes a third communications medium); and a wireless connection 20 (which constitutes an wireless medium). The network 10 of FIG. 1 is used to provide for communication between and amongst a plurality of rooms in the building. Thus, for example, each of nodes may be located in a different room of the residential building. Each of the nodes comprises a different multi-media device. Thus, the first node 12 comprises a Home Gateway (HGW) and the second node 14 comprises audio-visual entertainment apparatus.

Each of the first 12 and second nodes comprises a home networking integrated circuit (a GGL541 from Gigle Networks Ltd of Capital House, 2 Festival Square, Edinburgh, EH3 9SU, UK) provided within an appropriate enclosure. The home networking integrated circuit provides for communication over the wired communications media as is described below in more detail. Each of the first 12 and second nodes also comprises a wireless communications circuit that is operable according to at least one of the 802.11 standards, such as 802.11a, 802.11b, 802.11g, 802.11n, etc. Each network node is operative to provide for communication with a consumer product by way of an Ethernet communications controller and with the other nodes in the network over the communications media shown in FIG. 1. Reference should be made to publicly available product data from the vendor of the GGL541 and from a vendor of a wireless communications circuit, such as Intel, Broadcom, Marvell, Ralink, Atheros and CSR; such product data provides sufficient information for the skilled person to implement the network shown in

FIG. 1 without resorting to any more than ordinary design skill. Each node comprises a routing controller that comprises routing data in the form of a routing table containing device identifications for each of the other nodes in the network. The routing table is operative to identify a receiving node within the network that is to receive data. Hence, all possible paths other than a path between two nodes are effectively disabled.

A first embodiment of a node is represented in FIG. 2. More specifically, the embodiment 30 of FIG. 2 shows the physical and medium access control levels within the node. The node of FIG. 2 comprises a powerline medium transceiver 32 (which constitutes a first medium interface circuit), which is operative to interface with the powerline cable 16, 34. The node of FIG. 2 also comprises a coaxial cable interface circuit 36 (which constitutes a third medium interface circuit), which is operative to interface with the coaxial cable 18, 38. The powerline medium transceiver 32 is controlled by a first Medium Access Controller (MAC) 40 and the coaxial cable interface circuit 36 is controlled by a third Medium Access Controller (MAC) 42. A system Medium Access Controller 44 (which constitutes a communications controller) controls the splitting of data amongst the powerline cable 34, the coaxial cable 38 and the wireless connection, as is described below in more detail. The hitherto components described are formed as part of a first System on a Chip (SoC) (which constitutes a first unit) based upon the GGL541 mentioned above.

The node of FIG. 2 further comprises an 802.11 compliant transceiver 46 (which constitutes a second medium interface circuit), which is operative to interface with the wireless connection 20, 48. The 802.11 compliant transceiver 46 is controlled by a second Medium Access Controller (MAC) 50. The 802.11 compliant transceiver 46 and the second Medium Access Controller 50 form part of a second System on a Chip (SoC) (which constitutes a second unit). Communication between the system Medium Access Controller 44 and the second Medium Access Controller 50 is by way of an Ethernet connection 52.

The operation of the first embodiment will now be described with reference to FIGS. 1, 2. Movie data is to be transmitted between the first 12 and second 14 nodes. Each of the first and second Medium Access Controllers 40, 42 is operative to obtain information from its respective channel relating to quality of service measures, such as available bandwidth, latency and extent of packet loss. Also, the third Medium Access Controller 50 is operative to obtain information from the wireless connection 48 relating to quality of service measures, such as available bandwidth, latency and extent of packet loss; such information is conveyed to the system Medium Access Controller 44 by way of the Ethernet connection 52. This connection 52 is therefore done at layer II of the OSI model.

A quality of service metric is determined as described in WO 2008/142450 (to the present applicant) or WO 2008/142449 (to the present applicant), the contents of both of which are incorporated herein by reference. Then the system Medium Access Controller 44 is operative to determine how data should be split amongst the powerline cable, the coaxial cable and the wireless connection in dependence on the type of data being transmitted (i.e. a movie) and having regards to the quality of service information from the three media. The split data is then transmitted over the three media simultaneously. Alternatively there could be more than one flow of data (e.g. more than one movie) to be transmitted and/or received, that is, communicated between the first and second nodes 12, 14. Data can be received and/or transmitted using any combination of media in an asynchronous fashion. Thus, for example, the first and second media could be used to transmit while the third medium is used to receive or the first medium could be used to transmit and the second and third media used to receive. Alternatively, the first and third media could be used to receive while the second medium is used to transmit. Also, one of the media may not be used such that, for example, the third medium is not used while the first and second media are both used to transmit or receive or the third medium is not used while one of the first and second media is used to transmit and the other of the first and second media is used to receive.

To illustrate how the nodes actually communicate with each other when only on one of the networks, consider the following example of inter-node communication:
Node 1 has PLC MAC address 100 and wi-fi MAC address 110, and is the wi-fi access point (The access point must be a PLC and wi-fi node).
Node 2 is a wi-fi only node having MAC address 200
Node 3 is PLC only node having MAC address 300
Node 4 has PLC MAC address 400 and wi-fi MAC address 410 Communication from node 2 to node 3 is performed as follows:
   Node 1 publishes that it has access to MAC addresses 200,300,400,410 (regardless of whichever medium through which the MAC address is accessible to it) to the other PLC nodes,
   As node 2 (MAC address 300) is a wi-fi only node, all wi-fi nodes are required to send their data to the access point, even if they do not know where address 300 is,
   Node 1 then takes this data from the wi-fi interface and, as it is destined for a MAC address that is not known to the wi-fi network, sends it through the Ethernet interface to the system medium access controller and then on, through its PLC interface, to node 3 at MAC address 300.

It should be noted that at no point does a node that is on more than one network appear to have a single MAC address. For communication in their respective medium, every node retains its MAC address for that medium. However, on the PLC side of the network, tables of all visible MAC address are maintained which have both wi-fi and PLC addresses in the same table such that, for routing purposes, they are treated as addresses of a single network. Therefore, in other words, the wifi network is “slave” to the PLC network.

A second embodiment of a node is represented in FIG. 3. Components of the embodiment of FIG. 3 in common with FIG. 2 are designated by like reference numerals. Hence, the reader's attention is directed to the description given above for FIG. 2 in respect of common components. In contrast with the first embodiment, the second embodiment comprises a convergence layer controller 62 instead of the system medium access controller 44; the convergence layer controller 62 is operative to control the first and third medium access controllers 40, 42. The system medium access controller 64 of the second embodiment is associated with the wireless communications sub-system and thus forms part of the second System on a Chip. Communications between the first and second System on a Chip is by way of an Ethernet connection 52.

Operation of the second embodiment is the same as operation of the first embodiment, with the exception that quality of service information in respect of the powerline and coaxial cables is conveyed by the Ethernet connection to the system medium access controller 64 in the second

System on a Chip. As with the first embodiment, the system medium access controller 64 of the second embodiment is operative to determine how data should be split amongst the powerline cable, the coaxial cable and the wireless connection in dependence on the type of data being transmitted (i.e. a movie) and having regards to the quality of service information from the three media. The split data is then transmitted over the three media simultaneously, with the splitting of the data between the powerline and coaxial cables being under the control of the convergence layer controller 62.

In making a layer II of the OSI model link (through the Ethernet interface 52), between the two Systems on a Chip, the linked networks over the different mediums effectively become a single logical network. However it should be noted that, in both of the above embodiments, each of the systems retain their own MAC address and therefore each of them can belong to its own medium network. In this respect, each node maintains their separate MAC addresses when seen by any one of the other nodes in their respective wireless or powerline networks. For example, a Wi-Fi only system will see only the Wi-Fi part and Wi-Fi addresses but not the other (PLC/coaxial) addresses or parts. However, the PLC only nodes have knowledge of all the MAC addresses, as the powerline nodes and the dual PLC-Wi-Fi nodes publish them. Wi-Fi only devices are not aware about of the other MAC address because they send everything to the access point.

In addition to the splitting of data amongst different media as described above, data packets are routed over different media as described in WO 2007/039723. Furthermore, the network and the network nodes are operative to change between ordinary and power saving modes as described in each of GB 0914773.7 (to the present applicant), GB 0914775.2 (to the present applicant) and GB 0914774.5 (to the present applicant).

1-25. (canceled)

26. A communications apparatus comprising:
a first medium interface circuit that is operable to communicate data over a powerline medium;
a first medium access controller, which is operable to control the first medium interface circuit, the first medium access controller having a first MAC address;
a second medium interface circuit that is 802.11 compliant and which is operable to communicate data wirelessly;
a second medium access controller, which is operable to control the second medium interface circuit, the second medium access controller having a second MAC address; and
a communications controller that is operable to provide for communication of data simultaneously over the powerline medium and wireles sly by way of the first and second medium interface circuits;
wherein the first medium interface circuit and the second medium interface circuit are linked at the layer II level of the OSI model.

27. The communications apparatus of claim 26, further comprising a routing controller that comprises routing data, the routing data determining the identity of an apparatus with which the communications apparatus is to communicate.

28. The communications apparatus of claim 27, wherein the communications apparatus forms part of a network of communications apparatus, in which the routing data is in the form of a routing table containing device identifications for each of the other communications apparatus.

29. The communications apparatus according to claim 26, in which the communications controller appears to have one or more MAC addresses to other parts of the network, the MAC address or addresses visible to a particular node on the network being dependent on the medium or mediums through which the particular node and the communications apparatus are connected.

30. The communications apparatus according to claim 26, in which communications between the first medium interface circuit and the second medium interface circuit is by means of Ethernet in compliance with the 802.3 standard.

31. The communications apparatus according to claim 26, in which the first medium access controller and the first medium interface circuit are formed as part of a first System on a Chip (SoC) and the second medium access controller and the second medium interface circuit are formed as part of a second System on a Chip (SoC).

32. The communications apparatus of claim 31, wherein the communications controller forms part of the first System on a Chip.

33. The communications apparatus of claim 31, wherein the communications controller forms part of the second System on a Chip.

34. The communications apparatus of claim 31, wherein the first System on a Chip comprises a third medium interface circuit that is configured to, in use, communicate data over a different wired medium, the first System on a Chip comprises a convergence layer controller that is operative to control medium access controllers associated with the first and third medium interface circuits.

35. The communications apparatus of claim 31, wherein communications between the first and second Systems on a Chip are by means of a frame based standard.

36. The communications apparatus of claim 26, wherein the first and second medium access controllers and the first and second medium interface circuits form part of a single System on a Chip (SoC).

37. The communications apparatus of claim 26, wherein data is split between the first and second medium interface circuits in dependence on a quality of service measure.

38. The communications apparatus of claim 37, wherein the quality of service measure comprises at least one of: bandwidth, medium latency, extent of packet loss, a type of data to be communicated, and a condition of the data to be communicated.

39. The communications apparatus of claim 37, wherein the data is split in dependence on a quality of service measure that depends on a condition of at least one of the powerline medium and the wireless medium, the communications apparatus comprises at least one of:
a first medium access controller that is operative to obtain information from the powerline medium; and
a second medium access controller that is operative to obtain information from the wireless medium.

40. The communications apparatus of claim 39, wherein the communications apparatus is operative to convey the information obtained from a medium to the communications controller.

41. A communications apparatus comprising:
a first medium interface circuit that is operable to communicate data over a powerline medium with a second communications apparatus;
a first medium access controller, which is operable to control the first medium interface circuit, the first medium access controller having a first MAC address;
a second medium interface circuit that is 802.11 compliant and which is operable to communicate data wireles sly with the second communications apparatus;
a second medium access controller, which is operable to control the second medium interface circuit, the second medium access controller having a second MAC address; and
a communications controller that is operable to provide for communication of data simultaneously over the powerline medium and wireles sly by way of the first and second medium interface circuits;
wherein the first medium interface circuit and the second medium interface circuit are linked at the layer II level of the OSI model.

42. The communications apparatus of claim 41, wherein data is split between the first and second medium interface circuits in dependence on a quality of service measure comprising at least one of: bandwidth, medium latency, extent of packet loss, a type of data to be communicated, and a condition of the data to be communicated.

43. The communications apparatus of claim 42, wherein the data is split in dependence on a quality of service measure that depends on a condition of at least one of the powerline medium and the wireless medium, the communications apparatus comprises at least one of:
a first medium access controller that is operative to obtain information from the powerline medium; and
a second medium access controller that is operative to obtain information from the wireless medium.

44. A communications apparatus comprising:
a first medium interface circuit that is operable to communicate data over a powerline medium with a second communications apparatus;
a first medium access controller, which is operable to control the first medium interface circuit, the first medium access controller having a first MAC address;
a second medium interface circuit that is cable modem compliant and which is operable to communicate data over a cable medium with the second communications apparatus;
a second medium access controller, which is operable to control the second medium interface circuit, the second medium access controller having a second MAC address; and
a communications controller that is operable to provide for communication of data simultaneously over the powerline medium and wireles sly by way of the first and second medium interface circuits;
wherein the first medium interface circuit and the second medium interface circuit are linked at the layer II level of the OSI model.

45. The communications apparatus of claim 44, wherein data is split between the first and second medium interface circuits in dependence on a quality of service measure comprising at least one of: bandwidth, medium latency, extent of packet loss, a type of data to be communicated, and a condition of the data to be communicated.

46. The communications apparatus of claim 45, wherein the data is split in dependence on a quality of service measure that depends on a condition of at least one of the powerline medium and the wireless medium, the communications apparatus comprises at least one of:
a first medium access controller that is operative to obtain information from the powerline medium; and
a second medium access controller that is operative to obtain information from the wireless medium.
